(19) United States
(12) Patent Application Publication
(10) Pub. No.: US 2016/0246159 A1
(43) Pub. Date: Aug. 25, 2016

(54) CAMERA MODULE

(71) Applicant: Samsung Electro-Mechanics Co., Ltd., Suwon-si (KR)

(72) Inventors: Jung Seok LEE, Suwon-si (KR); Kyeong Jun KIM, Suwon-si (KR); Yoo Chang KIM, Suwon-si (KR); Sung Hoon KIM, Suwon-si (KR); Man Su KIM, Suwon-si (KR); Jae Ho BAIK, Suwon-si (KR); Po Chul KIM, Suwon-si (KR); Myung Ki LEE, Suwon-si (KR)

(73) Assignee: SAMSUNG ELECTRO-MECHANICS CO., LTD., Suwon-si (KR)

(21) Appl. No.: 14/944,847

(22) Filed: Nov. 18, 2015

(30) Foreign Application Priority Data
Feb. 25, 2015 (KR) 10-2015-0026701

(51) Int. Cl. G03B 3/10; G02B 7/02; G02B 7/04

(52) U.S. Cl. CPC G03B 3/10; G02B 7/04; G02B 7/022

(57) ABSTRACT

A camera module includes a first housing having at least one fixed lens mounted therein, a second housing coupled to the first housing and having a movable lens mounted therein, and an actuator configured to move the second housing relative to the first housing.

### CROSS-REFERENCE TO RELATED APPLICATION

This application claims the benefit under 35 USC 119(a) of Korean Patent Application No. 10-2015-0026701 filed on Feb. 25, 2015, in the Korean Intellectual Property Office, the entire disclosure of which is incorporated herein by reference for all purposes.

### BACKGROUND

1. Field

This application relates to a camera module having a rapid focusing function.

2. Description of Related Art

A high-resolution camera apparatus includes a plurality of lenses and an image sensor. Such a camera apparatus includes a moving means moving a lens barrel in an optical axis direction to obtain a clear image.

However, such a structure may be a hindrance in miniaturizing camera apparatuses, since the lens barrel, a member having significant mass, is moved to adjust a focal length, which leads to relatively high current consumption, and a structure of the moving mechanism thereof is complicated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first housing having at least one fixed lens mounted therein; a second housing coupled to the first housing and having a movable lens mounted therein; and an actuator configured to move the second housing relative to the first housing.

The camera module may further include an elastic member connecting the first housing and the second housing and supporting the second housing to enable the second housing to move relative to the first housing.

The actuator may include a coil member disposed on the first housing; and a magnet member disposed on the second housing.

The second housing may be mounted in the first housing.

The movable lens may include one or more protrusions extending perpendicularly to an optical axis of the movable lens.

A groove accommodating a portion of the movable lens may be formed in the second housing.

The second housing may have an opening configured to accommodate at least a portion of a fixed lens of the at least one fixed lens as the actuator moves the second housing relative to the first housing.

The camera module may further include a shield can accommodating the first housing and the second housing.

The camera module may further include a third housing coupled to the first housing and having at least one fixed lens mounted therein.

The second housing may be disposed between the first housing and the third housing.

The camera module may further include a sensor configured to sense a position of the second housing.

In another general aspect, a camera module includes a first housing having a fixed lens mounted therein; a second housing coupled to the first housing and having a movable lens mounted therein; and an actuator configured to move the movable lens relative to the fixed lens.

The camera module may further include an elastic member disposed in the second housing and supporting the movable lens to enable the movable lens to move relative to the second housing.

The actuator may include a coil member disposed on the second housing; and a magnet member disposed on the movable lens.

The camera module may further include a shield can accommodating the first housing and the second housing.

In another general aspect, a camera module includes a first housing having a fixed lens mounted therein; a second housing having a movable lens mounted therein; and an actuator configured to move the movable lens relative to the fixed lens; wherein the second housing is disposed between the first housing and an image plane of the camera module.

The movable lens may be a closest lens to the image plane of the camera module.

The camera module may further include an elastic member connecting the movable lens to the second housing and configured to enable the movable lens to move relative to the second housing.

The actuator may include a coil member disposed on the second housing; and a magnet member disposed on the movable lens.

The fixed lens may be one of a plurality of fixed lenses mounted in the first housing; and the movable lens may be the only lens mounted in the second housing.

Other features and aspects will be apparent from the following detailed description, the drawings, and the claims.

### BRIEF DESCRIPTION OF DRAWINGS

FIG. 1 is an exploded perspective view of an example of a camera module.

FIG. 2 is an assembled perspective view of the camera module illustrated in FIG. 1.

FIG. 3 is a cross-sectional view of the camera module taken along the line III-III in FIG. 2.

FIGS. 4 and 5 are cross-sectional views illustrating operating states of the camera module illustrated in FIG. 1.

FIGS. 6 and 7 are plan views illustrating a method of aligning an optical axis of a movable lens illustrated in FIG. 1.

FIG. 8 is a cross-sectional view of another example of a camera module taken along the line III-III in FIG. 2.

FIG. 9 is a cross-sectional view of another example of a camera module taken along the line III-III in FIG. 2.

FIG. 10 is a cross-sectional view of another example of a camera module taken along line the line III-III in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may embodied in different forms, and are not to be construed as being limited to the examples described herein. Rather, the examples described herein have been provided so that this disclosure will be thorough and complete, and will convey the full scope of the disclosure to one of ordinary skill in the art.

A camera module according to this application performs a rapid focusing function. For example, the camera module may only move one lens in an optical axis direction. As another example, the camera module may only move the smallest lens or the lightest lens in the optical axis direction.

Since the camera module as described above only moves one lens or the smallest or lightest lens, the amount of current necessary to drive the lens is reduced and a driving time needed to drive the lens is also reduced.

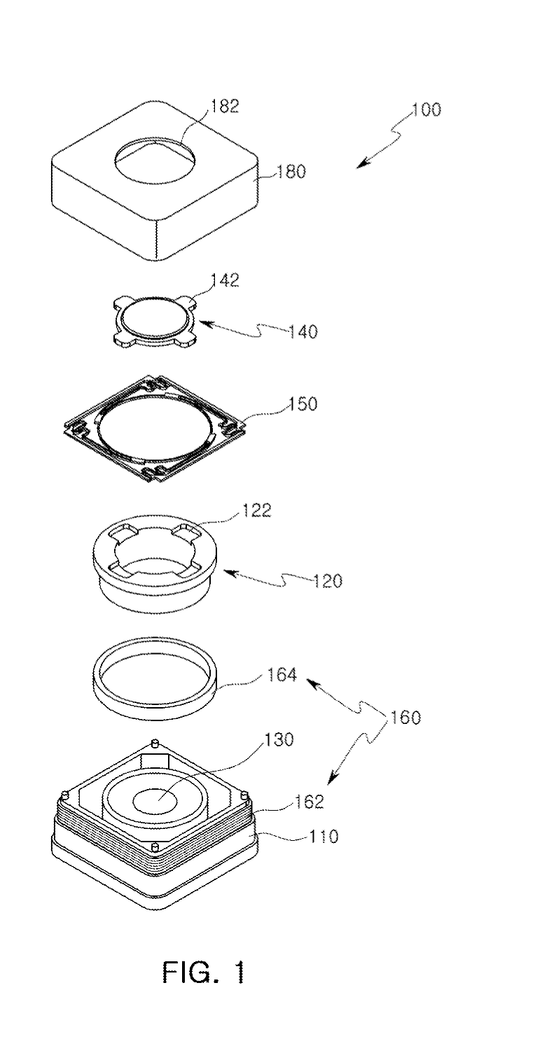

FIG. 1 is an exploded perspective view of an example of a camera module.

A camera module 100 includes a first housing 110, a second housing 120, a fixed lens 130, a movable lens 140, and an actuator 160. Further, the camera module 100 includes an elastic member 150 connecting the first housing 110 and the second housing 120. In addition, the camera module 100 includes a shield can 180 to block harmful electromagnetic waves.

The first housing 110 accommodates a plurality of components therein. For example, the first housing 110 accommodates one or more fixed lenses 130 therein. Further, the first housing 110 accommodates the second housing 120 therein. As another example, the first housing 110 accommodates a portion of the actuator 160.

The second housing 120 accommodates one or more movable lenses 140. In this example, the second housing 120 accommodates one movable lens 140. However, the number of movable lenses 140 accommodated in the second housing 120 is limited to one. For example, the second housing 120 may accommodate two or more movable lenses 140. The second housing 120 may partially accommodate the fixed lens 130. For example, one surface of the second housing 120 may have an opening to accommodate a portion of the fixed lens 130 as the second housing 120 is moved in the optical axis direction.

The second housing 120 is coupled to portions of the movable lens 140. In this example, grooves 122 into which the portions of the movable lens 140 are inserted are formed in the surface of the second housing 120.

The fixed lens 130 is mounted in the first housing 110. For example, one or more fixed lenses 130 are sequentially disposed in a height direction (a vertical direction in FIG. 1) of the first housing 110. The fixed lens 130 is fixed to the first housing 110. For example, one or more fixed lenses 130 may be firmly fixed to the first housing 110 by an adhesive or fastener.

The movable lens 140 is mounted in the second housing 120. In this example, one movable lens 140 is mounted on one surface of the second housing 120. The movable lens 140 is disposed to have the same optical axis as the fixed lens 130. For example, the optical axis of the movable lens 140 and an optical axis of the fixed lens 130 coincide with each other. This condition is advantageous in improving a resolution of the camera module 100.

The movable lens 140 is moved to adjust a distance between the movable lens 140 and the fixed lens 130. For example, the movable lens 140 is moved in the optical axis direction to adjust the distance between the movable lens and the fixed lens 130. For example, the movable lens 140 may be moved in a direction away from the fixed lens 130. Further, the movable lens 140 may be moved in a direction toward the fixed lens 130. The movement of the movable lens 140 is performed by the actuator 160.

The movable lens 140 is coupled to the second housing 120. In this example, the movable lens 140 includes one or more protrusions 142 inserted into the grooves 122 of the second housing 120.

The elastic member 150 connects the first housing 110 and the second housing 120. In this example, an edge portion of the elastic member 150 is connected to the first housing 110, and a central portion of the elastic member 150 is connected to the second housing 120.

The elastic member 150 is made of a material that may be easily deformed. Accordingly, the second housing 120 may be moved relative to the first housing 110. For example, as the elastic member 150 is deformed, the second housing 120 is moved out of the first housing 110 (an upward direction thereof in FIG. 1). As another example, as the elastic member 150 is deformed, the second housing 120 is moved into the first housing 110 (a downward direction thereof in FIG. 1).

The elastic member 150 may include a portion having a plate spring form. For example, a portion of the elastic member 150 connecting the first housing 110 and the second housing 120 may have the plate spring form.

The actuator 160 adjusts a position of the movable lens 140. In this example, the actuator 160 moves the second housing 120 in the optical axis direction to change the position of the movable lens 140.

The actuator 160 includes a coil member 162 and a magnet member 164. The actuator 160 moves the second housing 120 or the movable lens 140 by an electromagnetic force generated between the coil member 162 and the magnet member 164.

The coil member 162 may be disposed on the first housing 110. As another example, the coil member 162 may be disposed on an outer surface of the first housing 110.

The magnet member 164 may be disposed on the second housing 120. As another example, the magnet member 164 may be disposed on a portion of the second housing 120 facing the coil member 162.

The actuator 160 changes a direction of electromagnetic force generated between the coil member 162 and the magnet member 164 according to electrical signals applied to the coil member 162 to adjust a position of the second housing 120 or the position of the movable lens 140. As an example, the actuator 160 may move the movable lens 140 in the optical axis direction. As another example, the actuator 160 may tilt the movable lens 140 so that an optical axis of the movable lens 140 coincides with an optical axis of the camera module.

The shield can 180 protects the first housing 110 and the second housing 120. As an example, the shield can 180 protects components mounted in the first and second housings 110 and 120 from harmful electromagnetic waves. To this end, the shield can 180 may be formed of a metal. However, a material forming the shield can 180 is not limited to metal. As an example, the shield can 180 may be formed of a resin mixture including a metal powder or other metallic components.

The shield can 180 allows an effective light to be incident therethrough. For example, a hole 182 having substantially the same diameter as diameters of the lenses 130 and 140 is formed in one surface of the shield can 180. The hole 182 is formed in a position coinciding with the optical axes of the lenses 130 and 140 in one surface of the shield can 180.

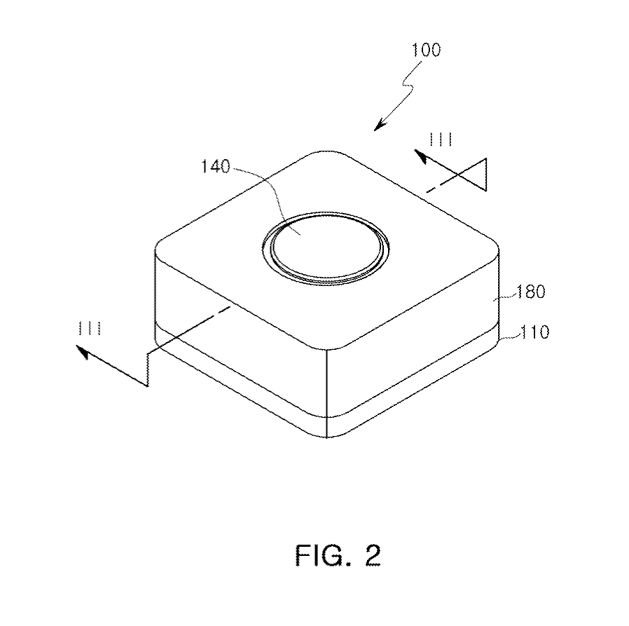

FIG. 2 is an assembled perspective view of the camera module illustrated in FIG. 1.

The camera module 100 is assembled to form a single part. As an example, the camera module 100 is assembled so that the first housing 110 accommodates all other components therein. As another example, the camera module 100 may be assembled so that a closed space formed by the first housing 110 and the shield can 180 accommodate all other components.

The camera module 100 may be easily mounted in a small portable electronic device.

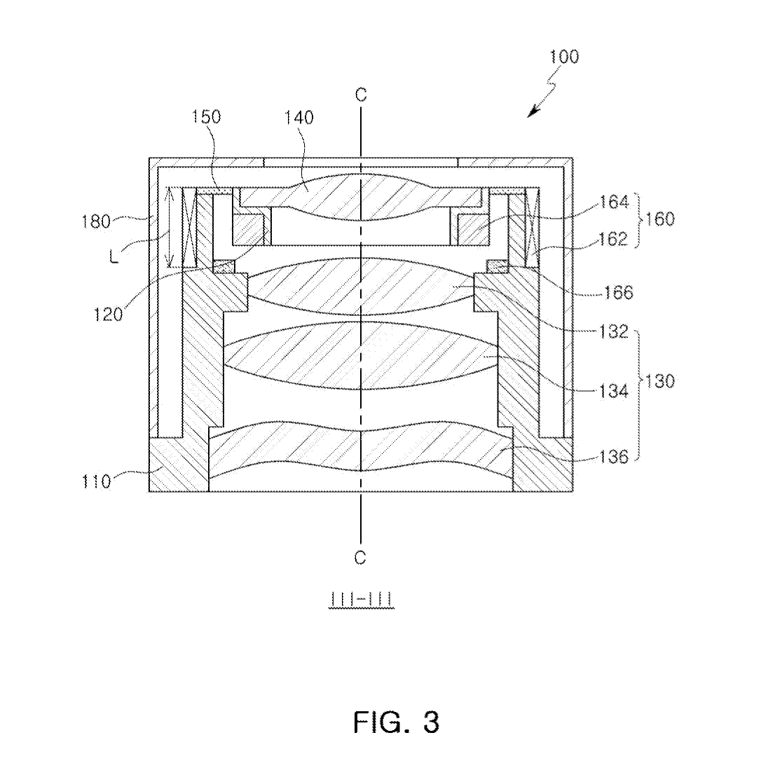

FIG. 3 is a cross-sectional view of the camera module taken along the line III-III in FIG. 2.

The camera module 100 is configured so that the fixed lens 130 and the movable lens 140 are sequentially disposed in the first housing 110. In this example, a plurality of fixed lenses 130 (132, 134, and 136) are sequentially disposed in a lower portion of the first housing 110, and the movable lens 140 is disposed in an upper portion of the first housing 110.

The second housing 120 is disposed in the first housing 110. In this example, the second housing 120 is disposed in the first housing 110 in a state in which the second housing 120 accommodates the movable lens 140.

The second housing 120 may be moved in the optical axis direction in the first housing 110. As an example, the second housing 120 may be moved downwardly or upwardly in the first housing 110 by the actuator 160.

The position of the second housing 120 is by a sensor 166. For example, the sensor 166 may sense magnetic force generated by the magnet member 164 formed on the second housing 120 to sense the position of the second housing 120. As another example, the sensor 166 may sense the position of the second housing 120 by sensing a magnitude of magnetic flux generated between the coil member 162 and the magnet member 164. For reference, a height L of the coil member 162 of the actuator 160 may advantageously be the same as a driving range of the second housing 120 or larger than the driving range of the second housing 120.

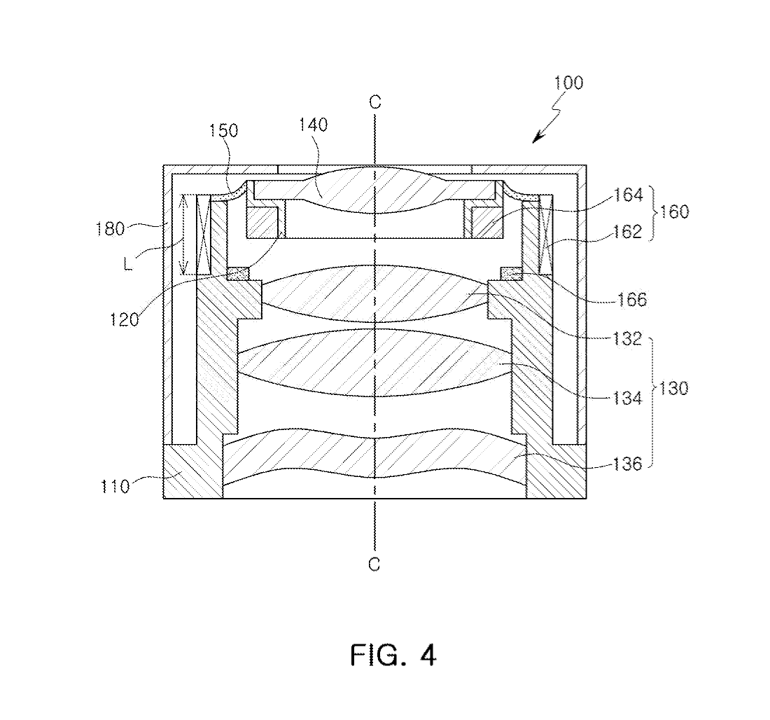

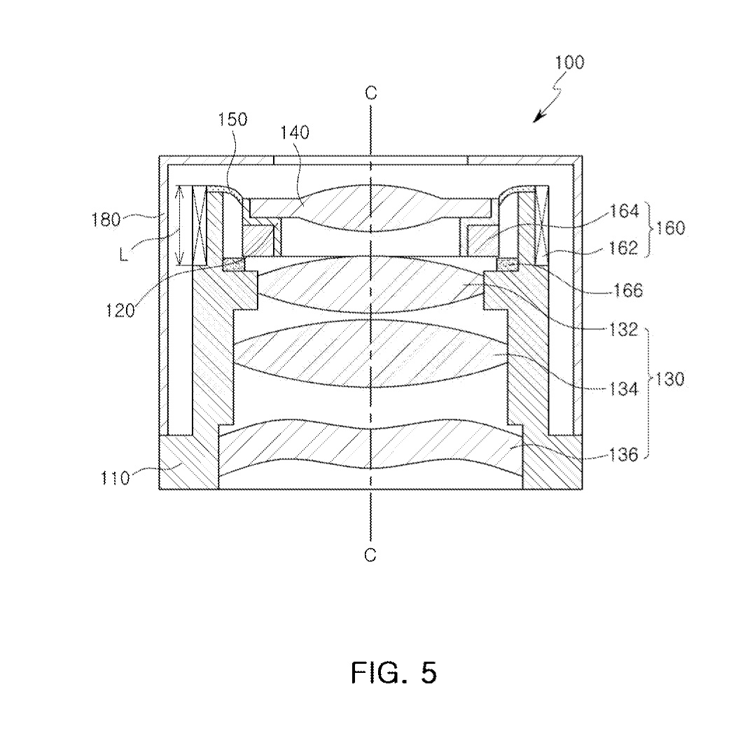

FIGS. 4 and 5 are cross-sectional views illustrating operating states of the camera module illustrated in FIG. 1.

The camera module 100 performs an auto-focusing function. As an example, the camera module 100 moves the movable lens 140 in a direction of a subject to enable a clear image of a distant subject to be captured (see FIG. 4). As another example, the camera module 100 moves the movable lens 140 in a direction of an image plane (a direction of an image sensor) to enable a clear image of a near subject to be captured (see FIG. 5). As another example, the camera module 100 freely moves the position of the movable lens 140 to enable a clear image of the subject to be captured regardless of the distance of the subject.

Since the camera module 100 only moves a few movable lenses 140 in the subject direction or the image plane direction, it may rapidly perform a focusing function. Further, in the camera module 100 in this example, since the actuator 160 only moves a few movable lenses 140 (one movable lens 140 in this example, it may significantly reduce an amount of current consumed in performing the focusing function.

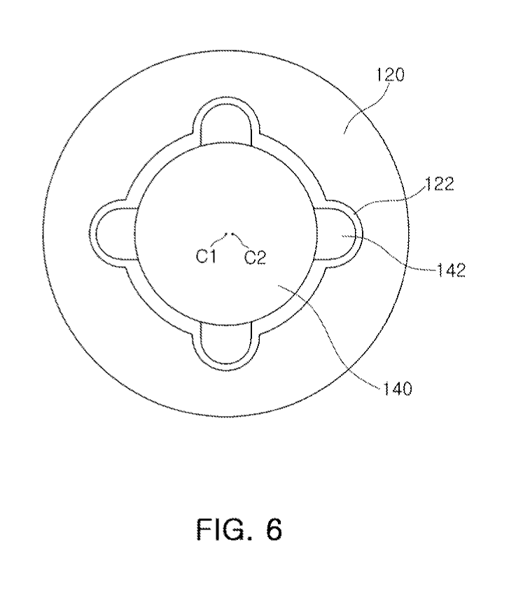

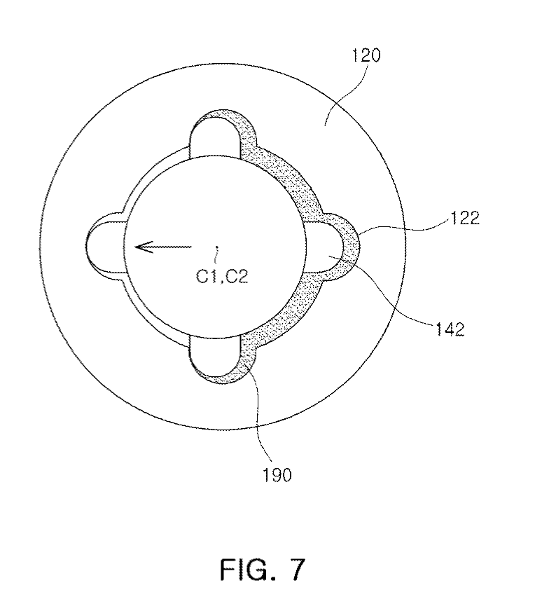

FIGS. 6 and 7 are plan views illustrating a method of aligning an optical axis of the movable lens 140.

The camera module 100 in this example enables an optical axis of the movable lens 140 to be aligned. For example, a position of the movable lens 140 in the second housing 120 may be adjusted. As an example, the movable lens 140 may be moved in a vertical direction of the optical axis and other directions in a length direction of the grooves 122 in a state in which the movable lens 140 is mounted in the second housing 120. To this end, the grooves 122 of the second housing 120 are formed to be larger than the protrusions 142 of the movable lens 140.

Next, a method of aligning an optical axis of the movable lens 140 will be described.

A method of aligning an optical axis of the movable lens 140 in this example is performed in the order of 1) mounting the movable lens 140, 2) aligning an optical axis of the movable lens 140, and 3) fixing the movable lens 140.

1) Mounting Movable Lens 140

The movable lens 140 is mounted in the second housing 120. As an example, the movable lens 140 is mounted in the second housing 120 by inserting the protrusions 142 into the grooves 122.

2) Aligning Optical Axis of Movable Lens 140

An optical axis C2 of the movable lens 140 is aligned with an optical axis C1 of the fixed lens 130. As an example, in a case in which the optical axis C2 of the movable lens 140 is not aligned with the optical axis C1 of the fixed lens 130 in a state in which the movable lens 140 is mounted in the second housing 120 (see FIG. 6), the optical axis C2 of the movable lens 140 is aligned with the optical axis C1 of the fixed lens 130 by moving the movable lens 140 in a calibration direction (see FIG. 7).

A series of processes of adjusting a tilting angle of the movable lens 140 may be further performed.

3) Fixing Movable Lens 140

The movable lens 140 and the second housing 120 are fixed together. As an example, the movable lens 140 is firmly fixed to the second housing 120 by applying an adhesive 190 in the grooves 122 of the second housing 120.

Next, another example of a method of aligning an optical axis of the movable lens 140 will be described. A method of aligning an optical axis of the movable lens 140 in this example is performed in the order of 1) mounting the movable lens 140, 2) temporarily fixing the movable lens 140, 3) aligning an optical axis of the movable lens 140, and 4) fixing the movable lens 140.

1) Mounting Movable Lens 140

The movable lens 140 is mounted in the second housing 120. As an example, the movable lens 140 is mounted in the second housing 120 by inserting the protrusions 142 into the grooves 122.

2) Temporarily Fixing Movable Lens 140

The position of the movable lens 140 is temporarily fixed. As an example, the position of the movable lens 140 in the second housing 120 is temporarily fixed by applying an adhesive to the grooves 122 of the second housing 120. The adhesive used here may be a type of adhesive that can be firmly cured by an additional curing process. As an example, a thermosetting or photo-setting adhesive may be used.

3) Aligning Optical Axis of Movable Lens 140

An optical axis C2 of the movable lens 140 is aligned with an optical axis C1 of the fixed lens 130. As an example, in a case in which the optical axis C2 of the movable lens 140 is not aligned with the optical axis C1 of the fixed lens 130 in a state in which the movable lens 140 is mounted in the second housing 120 (see FIG. 6), the optical axis C2 of the movable lens 140 is aligned with the optical axis C1 of the fixed lens 130 by moving the movable lens 140 in a calibration direction (see FIG. 7).

4) Fixing Movable Lens 140

The movable lens 140 and the second housing 120 are firmly fixed together. As an example, the adhesive 190 applied to the groove 122 of the second housing 120 is cured.

Next, other examples of a camera module will be described. For reference, in the following description, the same components as those of the example of the camera module described above will be denoted by the same reference numerals and detailed descriptions thereof will be omitted.

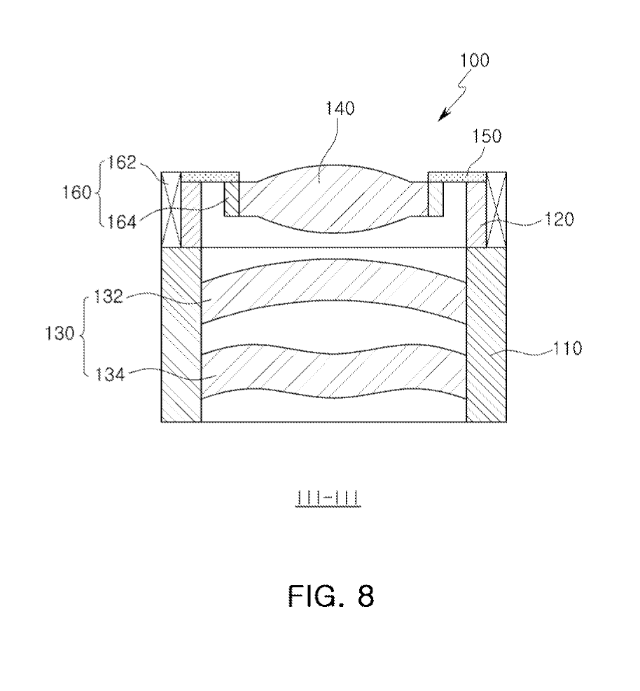

FIG. 8 is a cross-sectional view of another example of a camera module taken along the line III-III in FIG. 2.

The camera module 100 in this example is distinguishable from the camera module described above by an arrangement of the second housing 120. In this example, the second housing 120 is disposed in the upper portion of the first housing 110 so that the first housing 110 and the second housing 120 are disposed in series in the optical axis direction. This arrangement is advantageous for the camera module 100 including a plurality of lenses.

The camera module 100 in this example is distinguishable from the camera module described above by the coupling of the elastic member 150. For example, the elastic member 150 connects the second housing 120 and the movable lens 140. More specifically, the elastic member 150 connects the second housing 120 and the movable lens 140 so that the movable lens 140 may be moved relative to the second housing 120.

The camera module 100 in this example is distinguishable from the camera module described above by an arrangement of the actuator 160. In this example, the coil member 162 of the actuator 160 is disposed on the second housing 120, and the magnet member 164 of the actuator 160 is disposed on the movable lens 140.

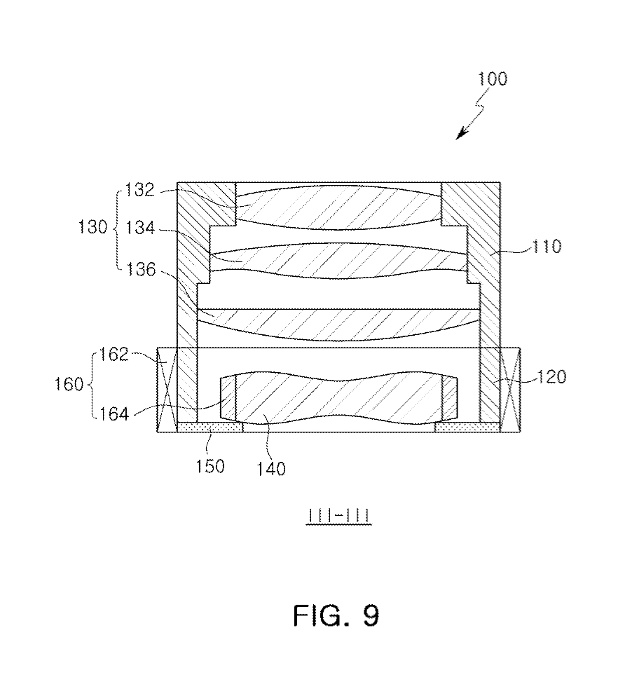

FIG. 9 is a cross-sectional view of another example of a camera module taken along the line III-III in FIG. 2.

The camera module 100 in this example is distinguishable from the camera modules described above by an arrangement of the second housing 120. In this example, the second housing 120 is disposed in the lower portion of the first housing 110 to accommodate a movable lens 140 that is a closest lens to an image side of the camera module 100. This arrangement is advantageous in a case in which sufficient space is provided in an image-side portion (e.g., a portion between an image-side lens and an image sensor) of the camera module 100. Alternatively, this arrangement is advantageous in a case in which a focusing function is effective due to the lens disposed on the image side.

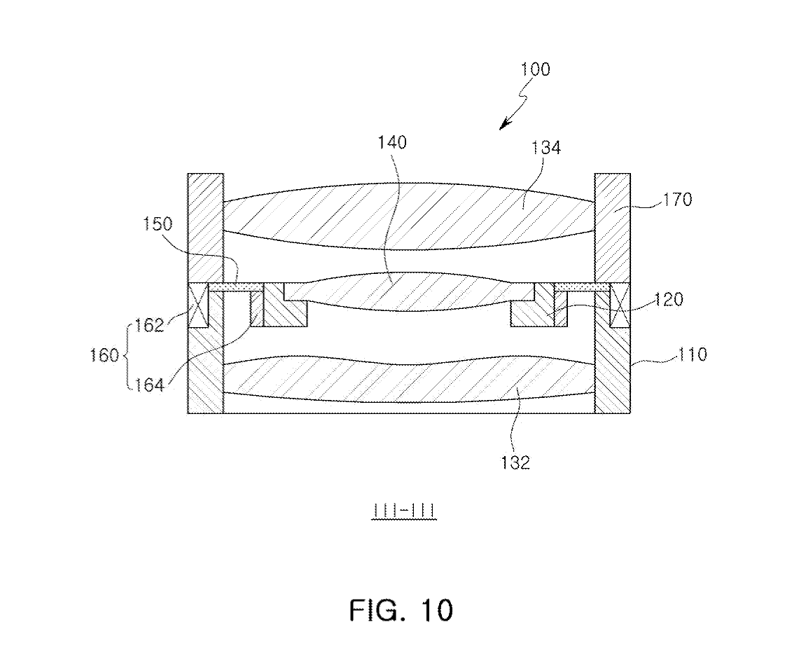

FIG. 10 is a cross-sectional view of another example of a camera module taken along the line III-III in FIG. 2.

The camera module 100 in this example is distinguishable from the camera modules described above in that the camera module 100 further includes a third housing. In this example, the camera module 100 further includes a third housing 170 accommodating another fixed lens 134. This example is advantageous in a case in which parts of the camera module 100 are manufactured separately. As an example, this example is advantageous in a case in which the first housing 110 is manufactured in an automatic production line and the third housing 170 is manufactured partially by hand.

The camera module 100 in this example is distinguishable from the camera modules described above in terms of an arrangement of the second housing 120. In this example, the second housing 120 is disposed between the first housing 110 and the third housing 170. This arrangement is advantageous in a case in which a focusing function is effective due to the lens disposed in the middle.

The examples described above enable the camera module to rapidly perform the focusing function.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a first housing having at least one fixed lens mounted therein;
a second housing coupled to the first housing and having a movable lens mounted therein; and
an actuator configured to move the second housing relative to the first housing.

2. The camera module of claim 1, further comprising an elastic member connecting the first housing and the second housing and supporting the second housing to enable the second housing to move relative to the first housing.

3. The camera module of claim 1, wherein the actuator comprises:
a coil member disposed on the first housing; and
a magnet member disposed on the second housing.

4. The camera module of claim 1, wherein the second housing is mounted in the first housing.

5. The camera module of claim 1, wherein the movable lens comprises one or more protrusions extending perpendicularly to an optical axis of the movable lens.

6. The camera module of claim 1, wherein a groove accommodating a portion of the movable lens is formed in the second housing.

7. The camera module of claim 1, wherein the second housing has an opening configured to accommodate at least a portion of a fixed lens of the at least one fixed lens as the actuator moves the second housing relative to the first housing.

8. The camera module of claim 1, further comprising a shield can accommodating the first housing and the second housing.

9. The camera module of claim 1, further comprising a third housing coupled to the first housing and having at least one fixed lens mounted therein.

10. The camera module of claim 9, wherein the second housing is disposed between the first housing and the third housing.

11. The camera module of claim 1, further comprising a sensor configured to sense a position of the second housing.

12. A camera module comprising:
a first housing having a fixed lens mounted therein;
a second housing coupled to the first housing and having a movable lens mounted therein; and
an actuator configured to move the movable lens relative to the fixed lens.

13. The camera module of claim 12, further comprising an elastic member disposed in the second housing and supporting the movable lens to enable the movable lens to move relative to the second housing.

14. The camera module of claim 12, wherein the actuator comprises:
a coil member disposed on the second housing; and
a magnet member disposed on the movable lens.

15. The camera module of claim 12, further comprising a shield can accommodating the first housing and the second housing.

16. A camera module comprising:
a first housing having a fixed lens mounted therein;
a second housing having a movable lens mounted therein; and
an actuator configured to move the movable lens relative to the fixed lens;
wherein the second housing is disposed between the first housing and an image plane of the camera module.

17. The camera module of claim 16, wherein the movable lens is a closest lens to the image plane of the camera module.

18. The camera module of claim 16, further comprising an elastic member connecting the movable lens to the second housing and configured to enable the movable lens to move relative to the second housing.

19. The camera module of claim 16, wherein the actuator comprises:
a coil member disposed on the second housing; and
a magnet member disposed on the movable lens.

20. The camera module of claim 16, wherein the fixed lens is one of a plurality of fixed lenses mounted in the first housing; and
the movable lens is the only lens mounted in the second housing.
